(19) United States
(12) Patent Application Publication
(10) Pub. No.: US 2010/0104802 A1
(43) Pub. Date: Apr. 29, 2010

(54) INSULATION LAYER FOR USE IN THERMAL INSULATION, INSULATION AND METHOD OF MANUFACTURING SUCH

(75) Inventor: Bruno Ekelund, Bastad (SE)

Correspondence Address: VOLPE AND KOENIG, P.C., UNITED PLAZA, SUITE 1600, 30 SOUTH 17TH STREET, PHILADELPHIA, PA, 19103, US

(73) Assignee: FIDENS HOLDING AB, Bjarred (SE)

(21) Appl. No.: 12/530,933

(22) PCT Filed: Mar. 20, 2008
(86) PCT No.: PCT/SE2008/050315

§ 371 Date: Sep. 11, 2009

Related U.S. Application Data
(60) Provisional application No. 60/907,106, filed on Mar. 21, 2007.

(30) Foreign Application Priority Data
Mar. 21, 2007 (SE) 0700707-3

(51) Int. Cl. F16L 59/065; F16L 59/08; B32B 3/10; B32B 5/02; B05D 5/00; D05B 97/00

(52) U.S. Cl. 428/138; 427/294; 112/475.01

(57) ABSTRACT

The present invention relates to an insulating layer for use in thermal insulation, including a radiation shield for reflecting thermal radiation and a spacer material which is attached to the radiation shield by means of a fastening material, from which insulating layer the air has been evacuated. The radiation shield of the insulating layer includes a plurality of through holes. The present invention also relates to an insulation for thermal insulation of an object as well as a method of manufacturing such an insulation.

### FIELD OF THE INVENTION

The present invention relates to an insulation layer for use in thermal insulation. The present invention also relates to an insulation for thermal insulation of an object and a method of manufacturing such an insulation.

### TECHNICAL BACKGROUND

Heat transfer from an arbitrary object to its surroundings is caused by convection, heat conduction and heat radiation. In order to avoid such heat transfer, there is a general need for thermal insulations. Insulations of simple constructions adapted to reduce the heat transfer are used in e.g. heat or cold preserving beverage containers such as Thermos®. In such a container, the content is insulated from the surroundings by an enclosing space of vacuum. Since vacuum reduces the heat transfer to radiation only, no heat transfer is caused by convection or conduction. Thus, an insulating effect is obtained which allows the beverage content inside the container to preserve its temperature.

There are higher demands put on the thermal insulation when the applications are more sophisticated. Some gases, e.g. nitrogen and oxygen, are preferred to be kept in liquid phase when they are transported and stored in order to enclose a higher amount of gas in the same container volume. In many cases, this requires either extremely low temperatures or extremely high pressures. High pressures are preferably avoided for safety reasons, which is why the gas container needs to be thermally insulated in order for the gas to preserve its low temperature.

The increase in heat transfer by radiation is according to Stefan-Boltzmann's law proportional to the fourth power of the difference in temperature between the object and the surroundings. It is thus necessary to reduce the heat transferred by radiation in cases where the difference in temperature between the object and the surroundings is large, e.g. as in the case of transporting and storing gas.

One method of reducing the heat radiation is to introduce several radiation shields in an enclosing space of vacuum. The radiation shields, which may be in the form of thin aluminium foil sheets, increase the total reflection of heat radiation. An intermediate layer may be arranged between the radiation shields to prevent the radiation shields from being in contact with each other, in which case they are allowing for heat conduction between the radiation shields. The intermediate layer is made of a material having a low heat conductivity. By attaching each radiation shield to the intermediate layer, the mounting of such insulation (also known as a Multi Layer Insulation) is simplified and the multi layer insulation is formed by winding the intermediate layer and the attached radiation shield in several layers around the gas container.

A schematic cross section of an insulating layer 10 according to prior art is shown in FIG. 1. The insulating layer is formed of a radiation shield 16 and an intermediate layer 12. The radiation shield 16 is attached to the intermediate layer 12 by means of a fastening material 14.

The multi layer insulation according to prior art causes long production times when the surrounding vacuum space is to be evacuated. The dense layers of aluminium foil also affect the production time, i.e. the time required for pumping vacuum in a negative manner,. Moreover, the efficiency of the insulation is reduced due to the fact that water which is bonded to the glass fibre may contribute to heat transfer caused by convection.

### SUMMARY OF THE INVENTION

One object of the present invention is to provide an improvement of the prior art as described above.

A particular object of the present invention is to provide an insulating layer and an insulation which reduce the production time and which have an improved efficiency.

According to the present invention, the above objects are achieved by an insulating layer for use in thermal insulation comprising a radiation shield for reflecting thermal radiation and a spacer material which is attached to the radiation shield by means of a fastening material, from which insulating layer the air has been evacuated. The insulating layer is characterised in that said radiation shield comprises a plurality of through holes.

This is advantageous in that the space that surrounds the insulating layer is evacuated faster.

The spacer material may be sewn to said radiation shield by means of a thread acting as fastening material, which is advantageous in that the radiation shield is attached to the spacer material in a simple and production-friendly manner.

The fastening material may be oxygen compatible, which is advantageous in that the insulation can be used for transporting and storing oxygen.

The fastening material may be inorganic, which is advantageous in that it is oxygen compatible.

The spacer material may comprise fibre, which is advantageous in that the spacer material thus can have a lower density, and consequently lower heat conductivity.

The spacer material may comprise glass fibre, which is advantageous in that easily accessible and cheap material can be used.

The fibre of the spacer material may comprise a surface that reflects thermal radiation. The heat radiation is thereby further reduced.

The cross section of the fibre of the spacer material may be oval, which allows alternative and cheaper methods of production.

The fibre of the spacer material may be spiral-shaped, which results in lower fibre density and consequently lower heat conductivity.

According to a second aspect of the present invention, an insulation for thermal insulation of an object is provided. The insulation comprises at least a first and a second insulating layer according to the first aspect of the invention, said first and second insulating layer being arranged adjacent to each other. Such insulation is advantageous in that it provides a more efficient insulation.

The insulating layers may be arranged such that the spacer material of the first insulating layer separates the radiation shield of the first insulating layer from the radiation shield of the second insulating layer. This is advantageous in that the spacer material prevents heat conduction between the radiation shields.

The number of insulating layers may be greater than 5, which allows for an even more efficient insulation.

The number of insulating layers may be lower than 50, which is advantageous in that a relatively thin and cheap insulation is provided.

According to a third aspect of the invention, a method of manufacturing an insulation for use in thermal insulation comprising at least one insulating layer having a radiation shield for reflecting thermal radiation and a spacer material is provided. The method is characterised by providing a plurality of through holes in the radiation shield, attaching the spacer material to the radiation shield, and evacuating air from the insulation.

The spacer material may be attached to the radiation shield by means of sewing, which is advantageous in that the radiation shield is attached to the spacer material in a simple and production-friendly manner.

The holes of the radiation shield may be formed by means of sewing, which reduces the number of production steps since attaching the layers and making the holes can be performed in a single step.

The spacer material may be coated with a surface that reflects thermal radiation, which is advantageous in that a product having an improved insulating property is obtained.

Further, at least a first and a second insulating layer may be arranged adjacent to each other such that the spacer material of the first insulating layer separates the radiation shield of the first insulating layer from the radiation shield of the second insulating layer. In this way, heat conduction from one radiation shield to another is avoided.

The advantages of the first and second aspects of the invention are also applicable for the third aspect of the invention.

The expression “oxygen compatible” indicates that a material is applicable in an environment with an increased oxygen rate without any risk of fire or explosion.

The advantages and features of the present invention described above are further disclosed in the detailed description as well as in the appended claims.

### BRIEF DESCRIPTION OF THE DRAWINGS

Further objects, advantages, features and embodiments of the invention will be apparent from the following description of a number of embodiments, in which reference is made to the appended drawings.

FIG. 1 shows schematically an insulation according to prior art.

FIG. 2 is a cross-sectional view of an insulating layer according to the present invention.

FIG. 3 is a cross-sectional view of an insulation according to the present invention.

FIG. 4 is a cross-sectional view of a gas container comprising an insulation according to the present invention.

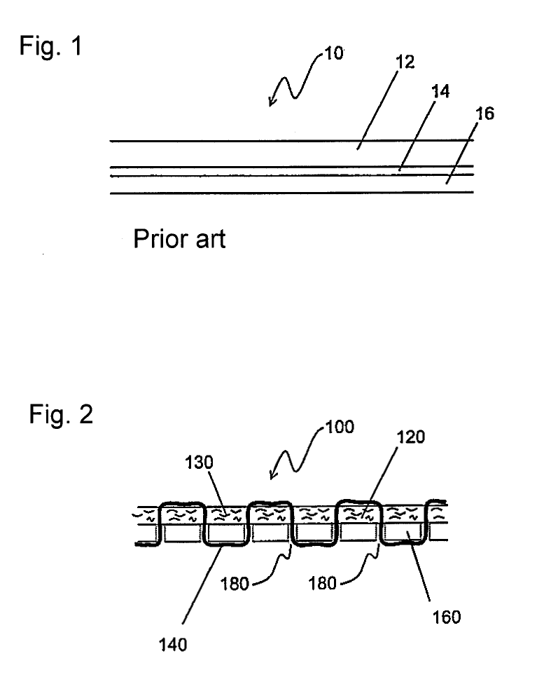

### DETAILED DESCRIPTION OF PREFERRED EMBODIMENTS

FIG. 2 shows an embodiment of an insulating layer 100 according to the present invention. The insulating layer 100 comprises a radiation shield 160 for reflecting thermal radiation and a spacer material 120. The radiation shield 160 is attached to the spacer material 120 by means of a fastening material 140. A plurality of holes 180 are provided in the radiation shield 160. The spacer material 120 consists of a fibre material comprising a quantity of fibres 130. The fastening material 140 consists of a thread, which runs right through the porous spacer material 120 and the holes 180 provided in the radiation shield 160. Thus, the spacer material 120 is sewn to the radiation shield 160. The insulating layer 100 is arranged in vacuum.

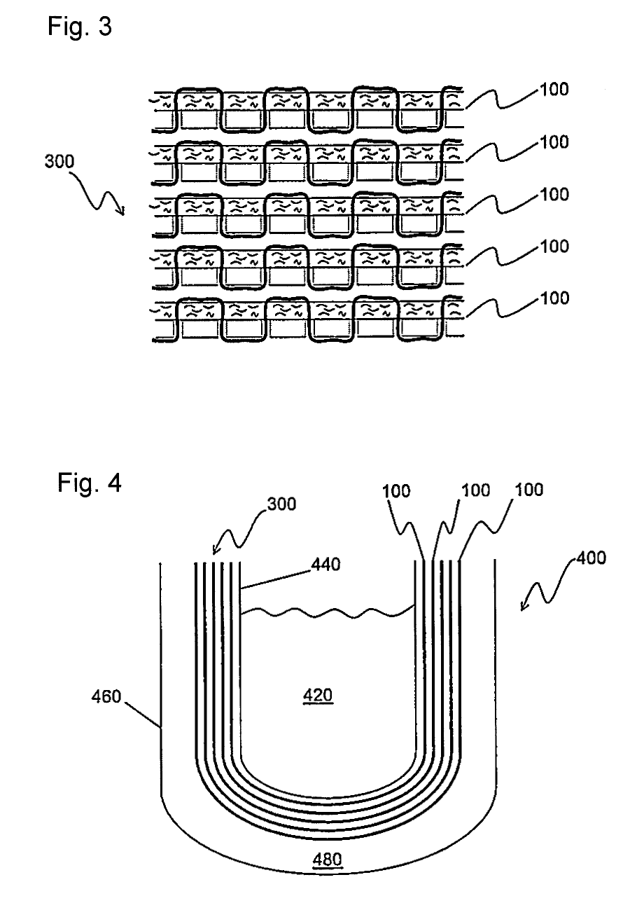

In FIG. 3, five insulating layers 100 according to FIG. 2 are shown which form an insulation 300, also known as a multi layer insulation. The insulating layers 100 are arranged such that the spacer material 120 of a first insulating layer 100 separates the radiation shield 160 of the first insulating layer 100 from the radiation shield 160 of a second insulating layer. Heat conduction from one radiation shield to another is thereby prevented.

FIG. 4 shows a gas container 400 having an insulation 300 according to the present invention. For example, the container 400 encloses a certain amount of liquid gas 420. The container 400 is further equipped with an inner wall 440 and an outer wall 440, which together define a space 480. The insulation 300, comprising a plurality of insulating layers 100, is provided in the space 480. The air of the space 480 is evacuated, thus providing vacuum. The insulating layers 100 are formed by one insulating layer 100 that is winded in several turns around the container 400. The number of turns may be more than 10, and fewer than 40.

The spacer material 120 is made of fibre material, e.g. glass fibre. The thermal conductivity of glass is approximately 1 W.m⁻¹.K⁻¹, that is to be compared with the thermal conductivity of aluminium which is approximately 235 W.m⁻¹.K⁻¹. Due to the fact that the glass is provided as fibre, thus allowing for a porous material, the thermal conductivity of the spacer material 120 is further reduced down to approximately 0.03 W.m⁻¹.K⁻¹. Of course, other materials having a low thermal conductivity, as for example plastics, can be used as spacer material as long as considerations are made due to possible demands for oxygen compatibility.

The fibre density of the spacer material 120 is low in order to minimize the heat conduction. When several insulating layers 100 are arranged adjacent to each other the spacer material 120 is compressed, which is why the fibre density must be high enough to separate the radiation shields 160 from each other.

The single fibres 130 can be formed in different ways in order to minimize the fibre density. When compressing the spacer material 120, the deformation of every single fibre 130 is reduced if the modulus of elasticity of the fibres is increased. The spacer material 120 can thereby have a lower density without causing the radiation shields 160 to engage with each other. The fibres 130 can further be provided with an optional shape. Such a shape can for example comprise a spiral shape, or any part of a spiral shape, such as a curved shape. A lower fibre density can thereby support a higher force of compression without the risk of the radiation shields 160 to engaging with each other. One way to achieve such a shape may be to provide the fibres 130 with an oval cross-section, for example by injecting the fibres through an oval mouthpiece during manufacturing. An inherent “curl” is thereby created in each fibre 130. Other methods known per se of manufacturing fibres can of course also be used. It should be noted that the adaptation of the spacer material 120 described above can be used as such to improve insulations, without being dependent on other features described herein.

An insulating layer 100 and an insulation 300 according to the invention can preferably be used for insulating a number of different objects. Some gases are subject to rigorous safety regulations. In particular, this is the case for explosive gases like oxygen and hydrogen. In order for the insulation to be applicable also together with such gases, all materials must be compatible with the gases that are contained inside the insulation. The radiation shield 160, the spacer material 120 and the fastening material 140 should thus be formed of specific materials. When insulating oxygen, the radiation shield 160 could be made of any metal such as aluminium, and the spacer material 120 could be made of glass fibre. A thread acting as fastening material 140 could also be made of glass fibre. In this case, the radiation shield 160 is sewn to the spacer material by means of the glass fibre thread. Other inorganic alloys can also be suitable for use in an insulating layer 100. In case of a more easily handled gas, like nitrogen, other materials such as plastics can be used. Thus, the material cost of the insulating layer 100 can be reduced.

In a further embodiment, the efficiency of the insulating layer 100 is improved by further reducing the heat transfer caused by radiation. Preferably, this is done by providing the spacer material 120 with a surface that reflects thermal radiation. Every single fibre 130 can, for example, be subject to metallization by any suitable process such as thermal evaporation, sputtering, etc. Moreover, the fastening material 140 can also be provided with such a reflective surface. By providing the spacer material 120 and/or the fastening material 140 with such a surface, the heat transfer between the radiation shields 160 is reduced. It should be noted that the adaptation of the spacer material 120 and the fastening material 140 described above can be used as such to improve insulations 300, without being dependent on other features described herein.

It will be appreciated that a number of modifications of the embodiments described herein can be made without departing from the scope of the invention as defined by the subsequent claims.

1. An insulating layer for use in thermal insulation, comprising a radiation shield for reflecting thermal radiation, said radiation shield being provided with a plurality of through holes, and a spacer material which is attached to the radiation shield by a fastening material, and air has been evacuated from the insulating layer,
said spacer material is sewn to said radiation shield by a thread as said fastening material.

2. The insulating layer according to claim 1, wherein the fastening material is oxygen compatible.

3. The insulating layer according to claim 2, wherein the fastening material is inorganic.

4. The insulating layer according to claim 1, wherein the spacer material comprises fibre.

5. The insulating layer according to claim 4, wherein the spacer material comprises glass fibre.

6. The insulating layer according to claim 4, wherein the fibre of the spacer material comprises a surface that reflects thermal radiation.

7. The insulating layer according to claim 4, wherein the cross section of the fibre of the spacer material is oval.

8. The insulating layer according to claim 4, wherein the fibre of the spacer material is spiral-shaped.

9. An insulation for thermal insulation of an object, comprising at least first and second insulating layers, said first and second insulating layers each including a radiation shield for reflecting thermal radiation, said radiation shield being provided with a plurality of through holes, and a spacer material which is attached to the radiation shield by a fastening material, and air has been evacuated from said first and second insulating layers, and said spacer material is sewn to said radiation shield by a thread as said fastening material, and, said first and second insulating layers being arranged adjacent to each other.

10. The insulation according to claim 9, wherein the insulating layers are arranged such that the spacer material of the first insulating layer separates the radiation shield of the first insulating layer from the radiation shield of the second insulating layer.

11. The insulation according to claim 9, wherein there are additional insulating layers and their number is greater than 5.

12. The insulation according to claim 9, wherein there are additional insulating layers and their number is lower than 50.

13. A method of manufacturing an insulation for use in thermal insulation which includes at least one insulating layer having a radiation shield for reflecting thermal radiation and a spacer material, said method comprising
providing a plurality of through holes in the radiation shield,
attaching the spacer material to the radiation shield by sewing, and
evacuating air from the insulation.

14. The method according to claim 13, wherein the holes of the radiation shield are formed by sewing.

15. The method according to claim 13, further comprising coating the spacer material with a surface that reflects thermal radiation.

16. The method according to claim 13, further comprising
arranging at least a first and a second insulating layers adjacent to each other such that the spacer material of the first insulating layer separates the radiation shield of the first insulating layer from the radiation shield of the second insulating layer.

17. The method according to claim 14, further comprising coating the spacer material with a surface that reflects thermal radiation.

18. The insulating layer according to claim 5, wherein the fibre of the spacer material comprises a surface that reflects thermal radiation.

19. The insulating layer according to claim 5, wherein the cross section of the fibre of the spacer material is oval.

20. The insulating layer according to claim 5, wherein the fibre of the spacer material is spiral-shaped.
